(19) United States
(12) Patent Application Publication
(10) Pub. No.: US 2016/0146131 A1
(43) Pub. Date: May 26, 2016

(54) TURBOCHARGER CONTROL DUTY DEVIATION COMPENSATION METHOD

(71) Applicants: Hyundai Motor Company, Seoul (KR); Kia Motors Corporation, Seoul (KR)

(72) Inventor: Dong-Han Hur, Gunpo-si (KR)

(73) Assignees: Hyundai Motor Company, Seoul (KR); Kia Motors Corporation, Seoul (KR)

(21) Appl. No.: 14/805,272

(22) Filed: Jul. 21, 2015

(30) Foreign Application Priority Data
Nov. 21, 2014 (KR) 10-2014-0163437

(51) Int. Cl. F02D 41/00; F02D 41/26; F02B 37/12

(52) U.S. Cl. CPC F02D 41/0007; F02B 37/12; F02D 41/263; F02D 2041/281

(57) ABSTRACT

A turbocharger control duty deviation compensation method may include judging a learning condition given deviation of a target position calculated using a turbocharger model and an actual position of a turbocharger together with atmospheric pressure, when a turbocharger control starts with a boost control duty value which matches with a required boost pressure target of an engine based on controller, calculating a learning value based on (100−target control duty)/(100−actual control duty) when the control duty deviation compensation control of the target control duty value calculated using the turbocharger actuator control duty model and the actual control duty value of the turbocharger are necessary, and acquiring a control to which any difference in the hardware-based characteristics of the driving mechanism related to the turbocharger are reflected since the control duty value of the target position is corrected with the calculated learning value, and the turbocharger is controlled.

### CROSS-REFERENCE TO RELATED APPLICATIONS

The present application claims priority of Korean Patent Application Number 10-2014-0163437 filed on Nov. 21, 2014, the entire contents of which application are incorporated herein for all purposes by this reference.

### BACKGROUND OF INVENTION

1. Field of Invention

The present invention relates to a turbocharger, and more particularly, to a turbocharger control duty deviation compensation method wherein a control duty of a turbocharger may be compensated given the characteristics of turbocharger hardware and the deviation in a predetermined part.

2. Description of Related Art

In general, a turbocharger applied to an intake system contributes to a fuel consumption improvement, an enhanced output and a NOx reduction by increasing the intake pressure in such a way to recycle exhaust energy.

The WGT (Waste Gate Turbocharger) and the VGT (Variable Geometry Turbocharger) may include a turbine configured to rotate using a flow (or kinetic) energy of the exhaust gas, a compressor which is connected through a rotary shaft to the turbine, thus compressing the air supplied to a combustion chamber, and a driving mechanism configured to variably regulate the passage area of the exhaust gas inputted into the turbine. The driving mechanism may include an actuator, a DC motor and a vacuum type solenoid valve and may be applied based on the characteristics of the WGT and the VGT. Therefore, a control of the WGT or the VGT may be associated with an ECU (Engine Control Unit).

For instances, the ECU serves to analyze an air pressure, a fuel injection and an engine revolution per minute (RPM) and to output as a duty value a target value of a boost pressure set based on a 3D boost map, so it is possible to secure more enhanced performance since the driving mechanism of the WGT and the VGT may be controlled in response to the duty value. In particular, the VGT may be advantageous to secure the boost pressure optimum in the whole RPM regions as compared with the WGT by variably regulating the passage area of the exhaust gas inputted into the turbine by using vanes.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The WGT or the VGT in general is configured to operate with the aid of the driving mechanism which may be controlled in response to a duty value of the ECU. However, the operations of the WGT or the VGT may not be accurately matched with the duty value since the duty value previously set in the ECU may not accurately reflect any difference in hardware-based characteristics of the driving mechanism such as a turbocharger and a DC motor, a solenoid valve, etc. or any deviation in a predetermined part. For instances, in case where an upper limit solenoid valve is used, the waste gate of the WGT may be opened since relatively stronger driving force may be applied, so a boost pressure may instantly go down, and oscillation and output may be lowered, and in case where a low limit solenoid valve is used, the durability of the turbocharger may be degraded because of the instant rising of the boost pressure since the force for opening the waste gate of the WGT is weak relatively.

The effects due to any difference in the hardware-based characteristics of the driving mechanism or any deviation in a predetermined part may be prevented a little with the aid of a feedback control of a boost pressure of the ECU, but in case where any difference in the hardware-based characteristics or the deviation in a predetermined part is large, the boost pressure response may become slow, and boost pressure oscillation may occur, which may result in instability in the control.

The present invention is directed to a turbocharger control duty deviation compensation method which may enhance the accuracy of a target boost pressure control of an engine in such a way that an WGT or an VGT may be controlled in response to a control duty value which accurately reflects any difference in the hardware-based characteristics of the driving mechanism related to the WGT and the VGT or any deviation in a predetermined part.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with various aspects of the present invention, a turbocharger control duty deviation compensation method includes: (A) a position difference detection step of detecting an actual position of an turbocharger, calculating a target position from a turbocharger model matching with the turbocharger, and determining position deviation of the actual position and the target position, when a control of the turbocharger starts using a boost control duty value which matches with a required engine boost pressure target value of an engine in which a controller is operable; (B) a deviation compensation judgment step of judging whether a control duty deviation compensation control of the boost control duty value is performed based on a learning condition given an atmospheric pressure and the position deviation; (C) a deviation compensation calculation step of calculating an actual control duty value based on the actual position, calculating a target control duty value based on the target position from a turbocharger actuator control duty model, and determining an learning value, when the control duty deviation compensation control is necessary; and (D) a learning value adoption step of correcting the target control duty value of the turbocharger with the learning value and controlling the turbocharger with the corrected control duty value of the turbocharger, when the control duty deviation compensation control is necessary.

The turbocharger model may calculate the target position by building a map using a turbocharger compressor pressure ratio and a turbocharger compressor flow rate diagram, and the turbocharger actuator control duty model may calculate the target control duty value by building a map using the turbocharger actuator position and the control duty diagram. The turbocharger may be a waste gate turbocharger or a variable geometry turbocharger.

In the deviation compensation judgment step, the learning condition may include a compressor pressure ratio, a boost pressure variation, a turbocharger position, a throttle use state, a sensor abnormal state, a cooling water temperature, an atmospheric temperature, a battery voltage, or any combination thereof.

In the deviation compensation calculation step, the learning value may be defined by a factor equal to (100−target control duty)/(100−actual control duty), and the learning value may be determined based on the factor, minimum limitation, maximum limitation and filtering.

In addition, to achieve the above objects, the turbocharger control duty deviation compensation method according to the present invention may further include a learning value no-application step of controlling the turbocharger with a control duty value which traces the target position when the control duty deviation compensation control is not necessary.

The present invention has several advantages. For example, the target boost pressure necessary for the engine may be accurately controlled since the control duty of the WGT or the VGT of the present invention may be accurately estimated by reflecting the effects due to any difference in the hardware-based characteristics of the driving mechanism or any deviations in a predetermined part.

In addition, a margin reduction is available based on a hardware-based limit (upper/middle/low limits) by way of an accurate control in such a way that the control duty of the WGT or the VGT of the present invention may reflect the effects due to any difference in the hardware-based characteristics of the driving mechanism and any deviation in a predetermined part, thus improving the performance of the hardware.

In addition, since the control duty of the WGT or the VGT of the present invention reflects the effects due to any difference in the hardware-based differences of the driving mechanism or any deviation in a predetermined part, and a variety of learning conditions including atmospheric pressure may be considered, the boost pressure control may be accurately performed under various environmental conditions.

In addition, since the control duty of the WGT or the VGT of the present invention may be accurately implemented without the use of a turbo position sensor, cost reduction may be possible.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating an exemplary turbocharger control duty deviation compensation method according to the present invention.

FIG. 2A, FIG. 2B, and FIG. 3 are exemplified views illustrating the performances of a turbocharger and an actuator to which the turbocharger control duty deviation compensation is applied, according to the present invention.

FIG. 4 is an exemplified view illustrating a target position calculation for the turbocharger control duty deviation compensation according to the present invention.

FIG. 5 is an exemplified view illustrating a learning condition for the turbocharger control duty deviation compensation according to the present invention.

FIG. 6 is an exemplified view illustrating a target position calculation for the turbocharger control duty deviation compensation according to the present invention.

FIG. 7 is an exemplified view illustrating a learning value calculation for the turbocharger control duty deviation compensation according to the present invention.

FIG. 8 is an exemplified view illustrating a turbocharger control duty output based on a result of the turbocharger control duty deviation compensation according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

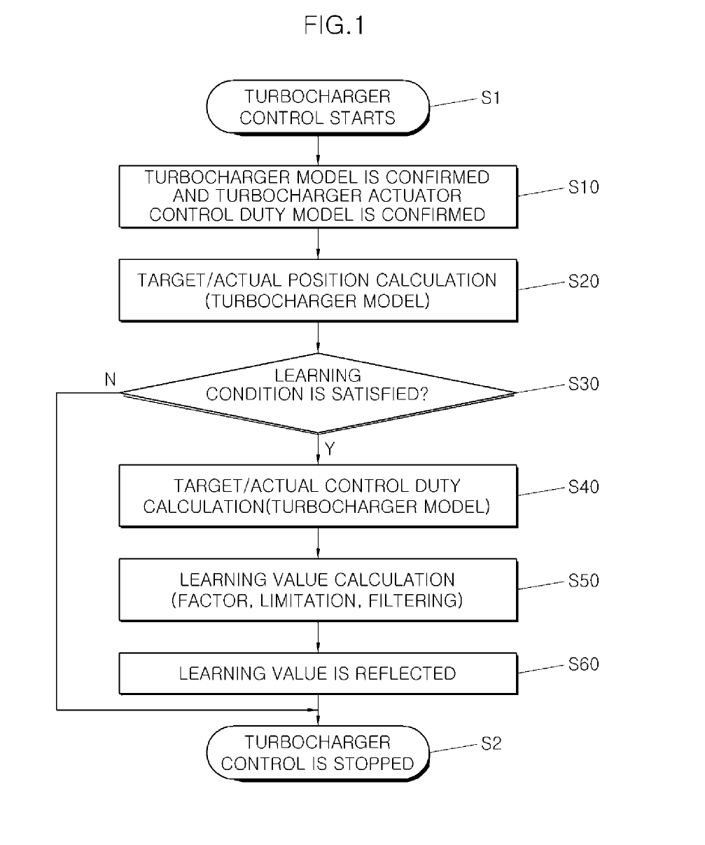

FIG. 1 is a flowchart illustrating a turbocharger control duty deviation compensation method according to some embodiments of the present invention. As illustrated therein, in the turbocharger control duty deviation compensation method according to the present invention, when a turbocharger control starts in the step S1, the learning value to which any difference in the hardware-based characteristics of the WGT or the VGT and the actuator which is a driving mechanism related to the WGT or the VGT or any deviation in a predetermined part, is accurately reflected, may be calculated, and the control of the WGT or the VGT is performed based on the learning value before the end of the turbocharger control in the step S2. In the present exemplary embodiment of the present invention, the learning value calculation and the control of the WGT or the VGT based on the learning value calculation are performed by the ECU (Engine Control Unit or Electronic Control Unit).

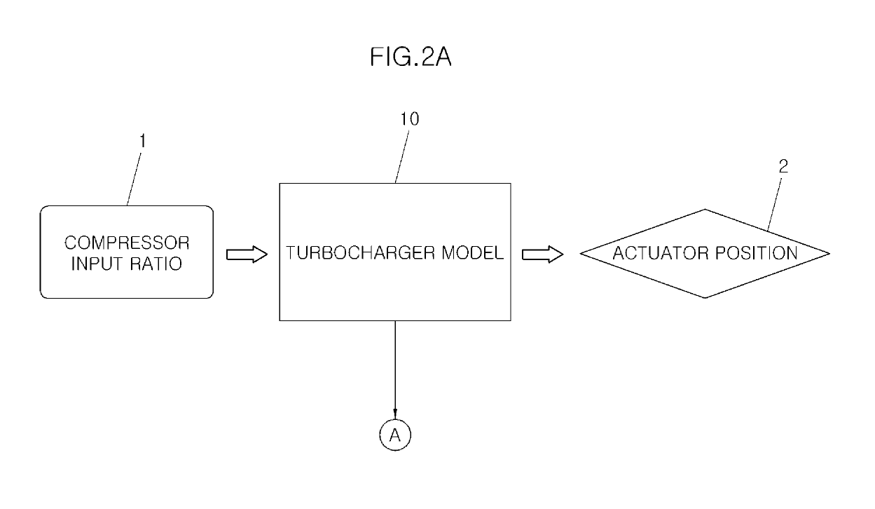

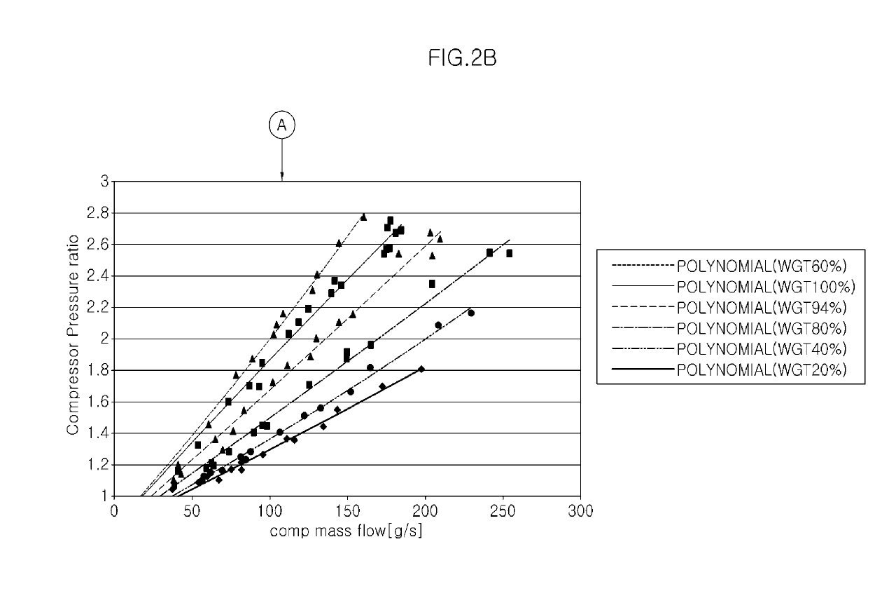

More specifically, in the step S10, a turbocharger model and a turbocharger actuator control duty model may be selected. The configuration example of the turbocharger model is illustrated in FIGS. 2A and 2B. As illustrated therein, the turbocharger model 10 generates as an output value a theoretical actuator position 2 by using as an input value a theoretical compressor pressure ratio 1. Such an operation may be acquired based on the fact that the turbocharger actuator position is a function between a compressor pressure ratio and a compressor flow rate, and the turbocharger actuator position may be estimated if the compressor pressure ratio and the compressor flow rate are known. In particular, the exemplified compressor pressure ratio represents an experimental value acquired through a direct experiment conducted with respect to an engine where hardware with a middle value is installed, among the performances categorized into an upper limit value/middle value/lower limit value of the turbocharger actuator. Therefore, the turbocharger control duty deviation compensation method may be applied to the WGT (Waste Gate Turbocharger) or the VGT (Variable Geometry Turbocharger) to which the diagram of the compressor pressure ratio is commonly applied, without any limits.

A configuration example of the turbocharger actuator control duty model is illustrated in FIG. 3. As illustrated therein, the turbocharger actuator control duty model 20 generates as an output value a theoretical control duty 3 by using as an input value the theoretical actuator position 2. Such an operation may be acquired based on the fact that the exemplified turbocharger actuator position is in proportion to the control duty. Therefore, since the driving mechanism is configured with a motor or a solenoid valve which is related to the actuator to which the control duty diagram is commonly applied, the application of the turbocharger control duty deviation compensation method may not be limited, provided that in case of the solenoid valve, for the DC motor, it is possible to previously establish a position relationship with the control duty in the same manner that the actuator position is determined by a spring constant in case of the solenoid valve, but it needs to consider that the correlation may partially differ between the actuator position and the control duty based on the deviations in the turbocharger and in a predetermined part of the driving mechanism.

Therefore, the turbocharger actuator control duty model selected in the step S10 may be a turbocharger model which has as a driving mechanism the solenoid valve or the DC motor. This turbocharger model may be either a WGT or a VGT, but since the WGT or the VGT of the present invention is controlled in the same manner, such a turbocharger model may be described as being a turbocharger without categorizing the kinds of the turbochargers into details. However, since it is obvious that only one of the WGT and the VGT is applied to one vehicle, if the system is designed for either the WGT or the VGT to be specifically applied to the turbocharger control duty deviation compensation method of the present invention, the turbocharger model selection procedure of the step S10 may be omitted.

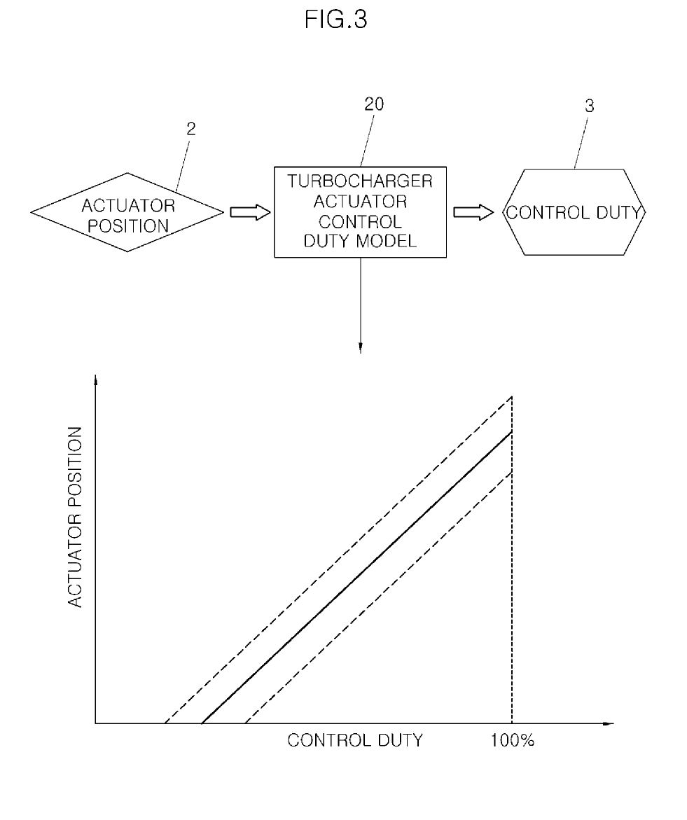

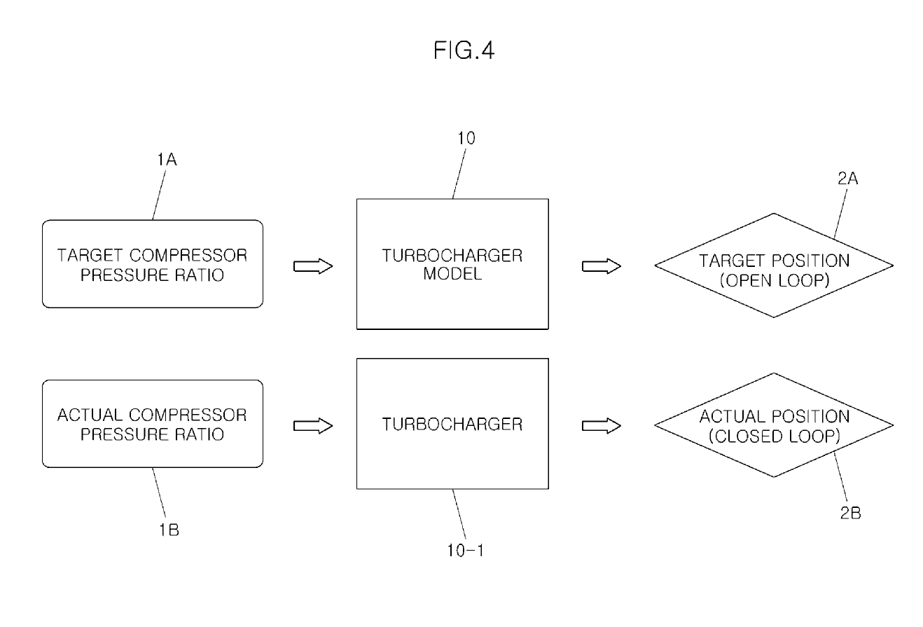

Turning back to FIG. 1, the target position and the actual position with respect to the turbocharger model selected in the step S10 is calculated in the step S20. As illustrated in FIG. 4, the target position 2A represents a theoretical position variation value to which the turbocharger actuator reacts in a state where the target compressor pressure ratio 1A is provided as an input value on the map built using the turbocharger model 10 applied to FIG. 2, and the actual position 2B represents an actual position variation value to which the turbocharger actuator reacts in a state where the actual compressor pressure ratio 1B is provided as an input value to the turbocharger of the WGT or the VGT which is the turbocharger 10-1 mounted on an actual vehicle.

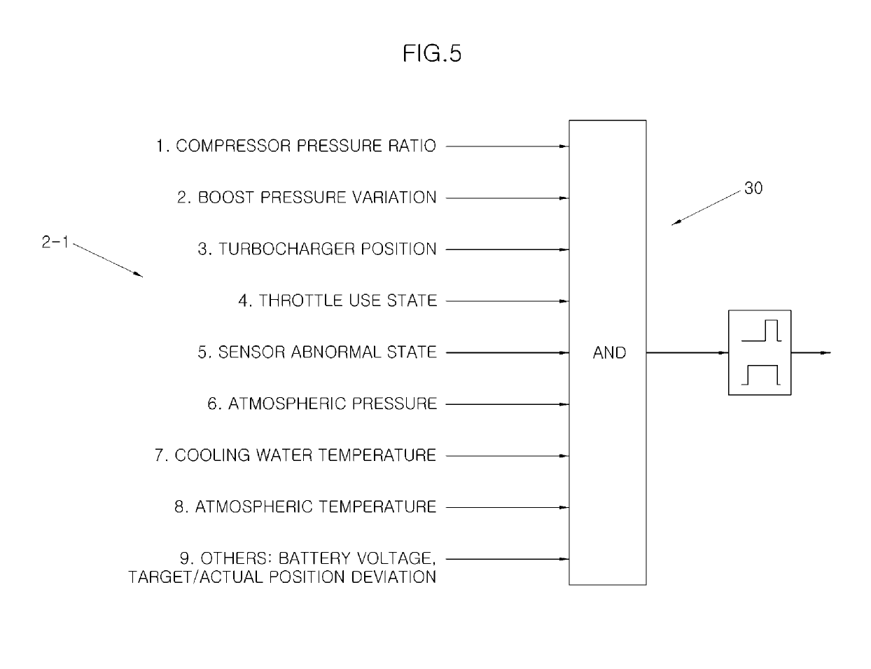

Whether the learning condition is satisfied may be judged in the step S30. As a result of the judgment, if the learning condition is not satisfied, the turbocharger actuator of the WGT or the VGT is controlled in response to the control duty which traces the target position, but if the learning condition is satisfied, the routine goes to the step S40 so as to perform the procedure for the sake of the turbocharger control duty deviation compensation. FIG. 5 is a view illustrating an example of the learning condition item 2-1 for the leaning condition judgment processed by the ECU 30, wherein the learning condition item 2-1 is formed of one or more of the following: a compressor pressure ratio, a boost pressure variation, a turbocharger position, a throttle use state, a sensor abnormal state, an atmospheric pressure, a cooling water temperature, an atmospheric temperature, a battery voltage, a target/actual position deviation, etc. Such data are the items which may be detected by a sensor, etc. installed at a vehicle, so the description thereon will be omitted.

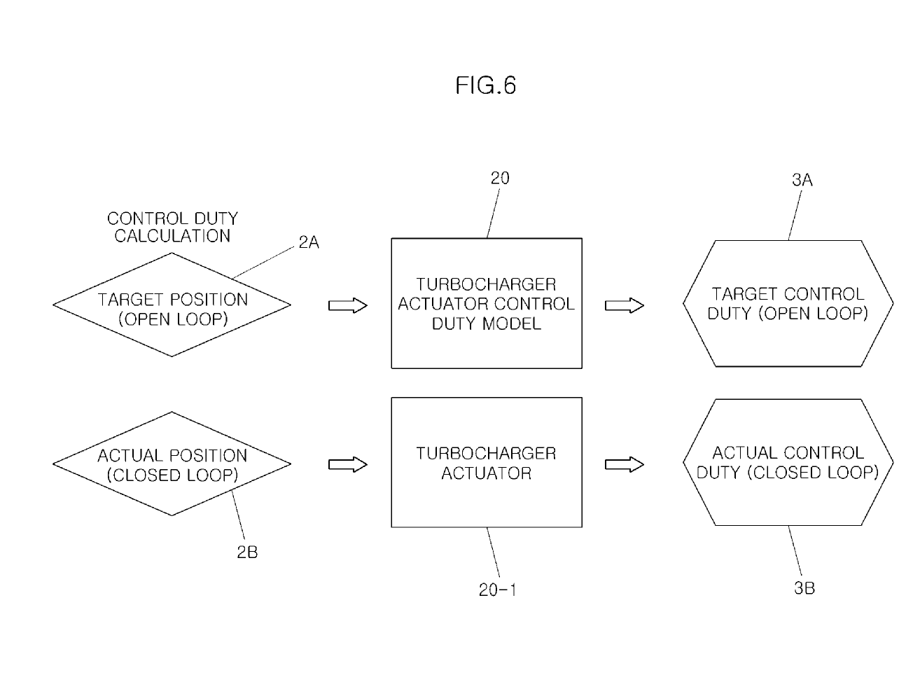

Turning back to FIG. 1, the target control duty and the actual control duty are calculated with respect to the turbocharger model selected in the step S10 in the step S40. As illustrated in FIG. 6, a target control duty 3A represents a theoretical output value wherein the target position 2A is provided as an input value on the map built using the turbocharger actuator control duty model 20 applied to FIG. 2 and is outputted as a control duty of the turbocharger actuator, and the actual control duty 3B represents an actual output value wherein an actual position 2B is provided as an input value to the turbocharger actuator 20-1 installed at an actual vehicle and is outputted as a control duty of the turbocharger actuator.

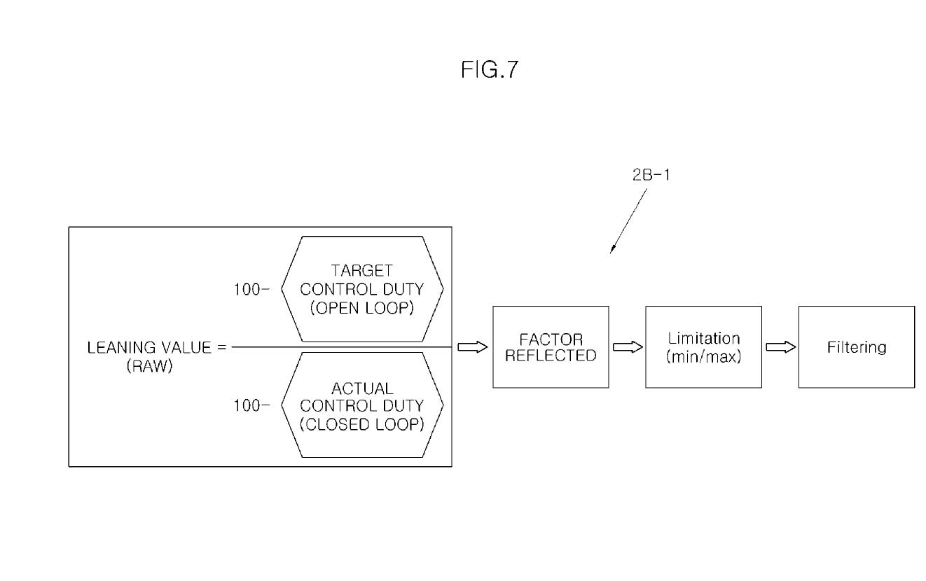

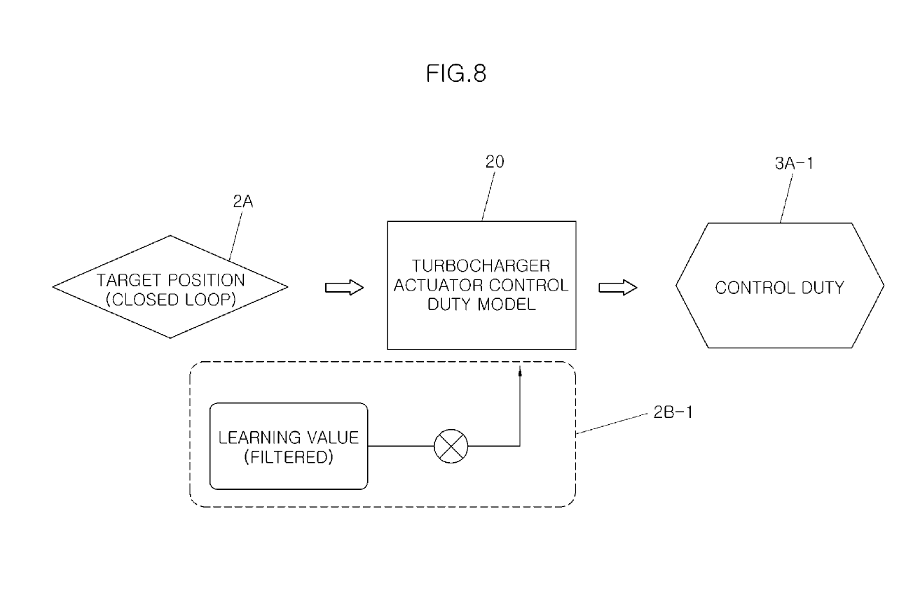

The learning value calculation may be performed in the step S50, and the calculated learning value is reflected or instantly reflected in the step S60, so any difference in the hardware-based characteristics of the selected turbocharger 10-1 and the turbocharger actuator 20-1 and any deviation in a predetermined part may be accurately corrected. FIG. 7 is a view illustrating an example of the learning value calculation, wherein the learning value=(100−target control duty)/(100−actual control duty), and the learning value 2B-1 may be determined by applying the factor and the limitations (minimum limitation/maximum limitation) and filtering with respect to the calculated learning value. Therefore, the target position 2A provided as an input value of the turbocharger actuator 20-1 as illustrated in FIG. 8 may be corrected with the learning value 2B-1, and as a result, the output value of the turbocharger actuator control duty model 20 turns into a correction control duty 3A-1 which is corrected with the learning value 2B-1 instead of the target control duty 3A which is not corrected with the learning value 2B-1.

As a result, since the turbocharger is controlled with the correction control duty 3A-1 of the controller, it is possible to implement a control to which any difference in the hardware-based characteristics of the WGT or the VGT and the actuator which is driving mechanism related to the WGT or the VGT or a deviation in a predetermined part are accurately reflected. In this case, the control duty value of the turbocharger may be permanently corrected with the learning value 2B-1.

As described above, in the turbocharger control duty deviation compensation method according to the present invention, when the turbocharger control is performed with a boost control duty value which matches with the required engine boost pressure target value of the engine by the controller, the learning condition is judged given the atmospheric pressure together with the deviations of the target position computed using the turbocharger model and the actual position of the turbocharger, and when it needs to perform the control duty deviation compensation controls of the target control duty value calculated using the turbocharger actuator control duty model and the actual control duty value of the turbocharger, the learning value may be calculated based on (100-target control duty/(100-actual control duty), and the turbocharger may be controlled since the control duty value based on the target position is corrected with the calculated learning value, so it is possible to perform a control to which any difference in the hardware-based characteristics of the driving mechanism related to the WGT or the VGT or any deviations in a predetermined part are accurately reflected.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A turbocharger control duty deviation compensation method, comprising:
(A) a position difference detection step of detecting an actual position of an turbocharger, calculating a target position from a turbocharger model matching with the turbocharger, and determining position deviation of the actual position and the target position, when a control of the turbocharger starts using a boost control duty value which matches with a required engine boost pressure target value of an engine in which a controller is operable;
(B) a deviation compensation judgment step of judging whether a control duty deviation compensation control of the boost control duty value is performed based on a learning condition given an atmospheric pressure and the position deviation;
(C) a deviation compensation calculation step of calculating an actual control duty value based on the actual position, calculating a target control duty value based on the target position from a turbocharger actuator control duty model, and determining an learning value, when the control duty deviation compensation control is necessary; and
(D) a learning value adoption step of correcting the target control duty value of the turbocharger with the learning value and controlling the turbocharger with the corrected control duty value of the turbocharger, when the control duty deviation compensation control is necessary.

2. The method of claim 1, wherein the turbocharger model calculates the target position by building a map with a turbocharger compressor pressure ratio and a turbocharger compressor flow rate diagram, and the turbocharger actuator control duty model calculates the target control duty value by building a map with the turbocharger actuator position and the control duty diagram.

3. The method of claim 2, wherein the turbocharger is a waste gate turbocharger or a variable geometry turbocharger.

4. The method of claim 1, wherein the learning condition includes a compressor pressure ratio, a boost pressure variation, a turbocharger position, a throttle use state, a sensor abnormal state, a cooling water temperature, an atmospheric temperature, a battery voltage, or any combination thereof.

5. The method of claim 1, wherein the learning value is defined by a factor equal to (100−target control duty)/(100−actual control duty).

6. The method of claim 5, wherein the learning value is determined based on the factor, minimum limitation, maximum limitation, and filtering.

7. The method of claim 1, further comprising:
(E) a learning value no-application step of controlling the turbocharger with a control duty value which traces the target position when the control duty deviation compensation control is not necessary.

8. The method of claim 1, wherein the controller is an ECU (Engine Control Unit).
